(19) United States
(12) Patent Application Publication
(10) Pub. No.: US 2026/0217001 A1
(43) Pub. Date: Jul. 30, 2026

(54) Decorative Floor Covering Element, and Method of Producing Such an Element

(71) Applicant: i4F Licensing NV, Turnhout (BE)

(72) Inventor: Eddy Alberic Boucké, Turnhout (BE)

(21) Appl. No.: 19/143,465

(22) PCT Filed: Dec. 28, 2023
(86) PCT No.: PCT/EP2023/087938

§ 371 Date: Jun. 26, 2025

(30) Foreign Application Priority Data
Dec. 28, 2022 (NL) 2033857

(51) Int. Cl. B32B 25/12; B32B 3/06; B32B 7/12; B32B 38/00

(52) U.S. Cl. CPC B32B 25/12; B32B 3/06; B32B 7/12; B32B 38/145; B32B 2038/0076; B32B 2305/72; B32B 2307/4023; B32B 2307/412; B32B 2307/72; B32B 2310/0831; B32B 2471/00

(57) ABSTRACT

The invention relates to a decorative floor covering element, in particular a floor panel, wall panel, or ceiling panel. The invention further relates to a method of producing a floor covering element according to any of the foregoing claims, including the steps of A) providing at least one core layer, B) applying a decorative top structure, either directly or indirectly, on an upper side of said core layer, and C) applying a backing layer, either directly or indirectly, on a lower side of said core layer.

### CROSS-REFERENCE TO RELATED APPLICATIONS

This application is the United States national phase of International Patent Application No. PCT/EP2023/087938 filed Dec. 28, 2023, and claims priority to The Netherlands Patent Application No. 2033857 filed Dec. 28, 2022, the disclosures of which are hereby incorporated by reference in their entireties.

### BACKGROUND OF THE INVENTION

### Field of the Invention

The invention relates to a decorative covering element, in particular a decorative floor covering element, such as a floor panel, a decorative wall covering element, such as a wall panel, a decorative ceiling covering element, such as a ceiling panel, wall panel, or ceiling panel. The invention further relates to a method of producing a decorative covering element, in particular a floor covering element, as described herein, comprises the steps of: A) providing at least one core layer, B) applying a decorative top structure, either directly or indirectly, on an upper side of said core layer, and C) applying a backing layer, either directly or indirectly, on a lower side of said core layer.

### Description of Related Art

The flooring industry uses mainly traditional core materials for manufacturing (laminated) floor tiles. Examples of commonly used materials for composing a core layer of the known floor tiles are high density fiberboard (HDF) which can be merged together by a formaldehyde or phenol-based resin, heterogeneous or homogeneous polyvinyl chloride (PVC) which may possibly comprise any plasticizers, pieces of solid hardwood, or layers of veneers glued together, and fired and glazed clay such as ceramic and porcelain tiles. The purpose of use of these materials depends mainly on their material properties such as impact resistance, rigidity, acoustic performance and/or appearance. Often at least one backing layer affixed to the core, which backing layer may act as balancing layer. An example of such a balancing layer is a layer which comprises lignocellulose and a cured resin. The backing layer may also be formed by an acoustic layer, which is usually composed of a low density foamed layer of ethylene-vinyl acetate (EVA) or crosslinked polyethylene (XPE). Recently there is an increasing interest in the use of alternative materials due to a demand from the market for better performing, greener or more sustainable products.

### SUMMARY OF THE INVENTION

It is a first object of the invention to provide an improved decorative covering element with a more sustainable backing layer.

It is a second object of the invention to provide an improved decorative covering element with a relatively environmental-friendly and/or more sustainable backing layer which can be used relatively safely.

It is a third object of the invention to provide an improved decorative covering element with a relatively environmental-friendly and/or more sustainable backing layer which is less susceptible for microbial growth.

At least one of these objects can be achieved by providing a decorative covering element, in particular a decorative floor covering element, such as a floor panel, according to the preamble, comprising:
at least one core layer,
a decorative top structure affixed, either directly or indirectly, on an upper side of said core layer, and
a backing layer affixed, either directly or indirectly, on a lower side of said core layer,
   wherein said backing layer is at least partially composed of an at least one partially cured, in particular UV cured, natural rubber comprising rubber chains that are at least partially crosslinked by at least one organic, preferably sulphur-free, crosslinking agent, and which natural rubber comprises at least one photo-initiator and/or at least one photo-initiator derivative.

The decorative covering element according to the invention may be a decorative floor covering element, such as a floor panel, a decorative wall covering element, such as a wall panel, a decorative ceiling covering element, such as a ceiling panel, wall panel, or ceiling panel, and will hereinafter simply be referred to as floor covering element. The floor covering element according to the invention has several advantages. Firstly, the backing layer of the floor covering element is at least partially, and preferably entirely, composed of a natural material, being natural rubber. This natural material is durable, abrasion resistant, vibration dampening, and costs less than many alternative synthetic polymers, like EVA. Moreover, natural rubber boasts a large stretch ratio, high resilience and is extremely waterproof. Since the rubber is cured (vulcanized) by using ultraviolet (UV) radiation, the rubber becomes at least partially UV cured. This curing system does not require, and preferably does not use sulphur and traditional sulphur based curing systems. Allergenic reactions are associated with sulphur comprising chemicals used during sulphur-based (pre) vulcanization. Since the UV cured natural rubber used in the floor covering element according to the invention does not require, and preferably does not use, any sulphur to crosslink rubber chain, the chance of allergenic reactions occurring as a result of the use of the floor covering element, in particular during touching the exposed backing layer, is reduced significantly. Furthermore, the natural rubber used in the backing layer is preferably an unfoamed (solid) layer, which inhibits microbial growth, and which makes this material more microbial resistant compared to porous and/or foamed materials, like EVA. A further advantage of the use of natural rubber in the backing layer of the floor covering element according to the invention is that the natural rubber can be given, dependent on the state of cure (crosslinking density), a surface tackiness (surface stickiness), which allows the rubber to fixate the floor covering element with respect to a subfloor, which is in favour of the stability of a floor covering composed of a plurality of such floor covering elements.

Preferably, said backing layer is directly attached to the lower side of the core, without intermediate adhesive. This may, for example, be realized by applying the natural rubber based backing layer in a tacky state (sticky state) and by pressing said tacky backing layer against and/or onto the core layer, optionally followed by an UV curing treatment and/or heat treatment. Preferably, the crosslink density of the natural rubber used in the backing layer is between 150 and 400 mol per kg natural rubber.

Said backing layer may also indirectly be attached to the lower side of the core. For example, at least one functional layer may be situated in between said core layer and said backing layer, and wherein said backing layer is directly attached to said at least one functional layer. Said functional layer(s) may, for example, be a balancing layer, and/or an acoustic layer, and/or a heat dissipating layer and/or a reinforcing layer, and/or a combination of two or more of these layers, etcetera. Preferably, if at least at least one functional layer is attached to the lower side of the core, then said backing layer is preferably directly attached to said at least one functional layer without intermediate adhesive.

Preferably, said natural rubber comprises rubber chains at least partially crosslinked by at least one branched organic, preferably sulphur-free, crosslinking agent. Preferably, each cross-links comprises a backbone which comprises at least five carbon atoms, and optionally oxygen atoms. This creates sufficient space in between the rubber chains, also to accommodate optional side branches of the crosslinks. As indicated above, preferably, said natural rubber comprises rubber chains at least partially crosslinked by at least one, preferably branched, organic, sulphur-free crosslinking agent.

Said natural rubber preferably comprises at least one photo-initiator chosen from the group consisting of: α-hydroxyphenylketone, 2,2-dimethoxy-2-phenyl acetophenone, triarylphosphine oxide, bisacylphosphine oxide, bis(2,4,6-trimethylbenzoyl)-phenylphosphineoxide, 2-hydroxy-2-methyl-1-phenylpropanone. This latter compound is also known as Irgacure 1173 (and as Omnirad 1173), which can be obtained from BASF. It is imaginable that these compounds are still present in the natural rubber after UV curing. At least a fraction of these compounds (or any other suitable photo-initiator) will be cleaved, typically homolytically, into, radicals on absorbing UV light during UV curing. These radicals are suitable to react with the rubber chains and/or the crosslinking agent to initiate and/or propagate the crosslinking process. The aforementioned radicals will typically become part of the crosslinks in between the rubber chains. These radicals are considered as photo-initiator derivatives. Hence, the said crosslinking agent (in crosslinked state (crosslinking adjacent rubber chains)) preferably comprises at least one photo-initiator derivative. In case, 2-hydroxy-2-methyl-1-phenylpropanone is used, for example, as initial photo-initiator, then this molecule is cleaved by UV light into a benzoyl radical and an isopropanol radical. These reactive radicals are typically and preferably reacting with the crosslinking agent to become part—as benzoyl group and isopropanol group—of the crosslinking agent and/or of the crosslinking bridge based upon said crosslinking agent.

The crosslinking agent comprises and/or is based upon acrylate, such as polyfunctional acrylates, like trimethoxypropane triacrylate or any other triacrylate. These polyfunctional acrylates are self-initiating when exposed to UV light. Preferably, said crosslinking agent comprises and/or is based upon 1,9-bis(acryloyloxy) nonane. This latter preferred compound is suitable to form monoradicals and/or biradicals. Natural rubber chains typically comprise polyisoprene, preferably cis-1,4-polyisoprene. Hence, as an example, a UV based crosslinking mechanism (curing system), based upon cis-1,4-polyisoprene (natural rubber), 1,9-bis(acryloyloxy) nonane (crosslinking agent), and 2-hydroxy-2-methyl-1-phenylpropanone, could be described and depicted as follows. In a first step, absorption of UV light results in the formation of benzoyl and isopropanol radicals via homolytic cleavage of 2-hydroxy-2-methyl-1-phenylpropanone.

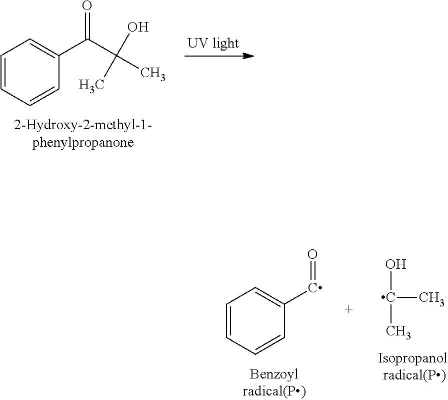

These radicals (P·) initiate (pre)vulcanization by attacking the C═C bonds of the nearest molecules of polyisoprene (rubber chains) and the crosslinking agent. The reaction between the radicals of the photo-initiator and the polyisoprene chains produces polymer radicals, whereas the reaction between the radicals of the photo-initiator and 1,9-bis(acryloyloxy) nonane generates products with one or two radical centres. These are the monoradical and the biradical, respectively.

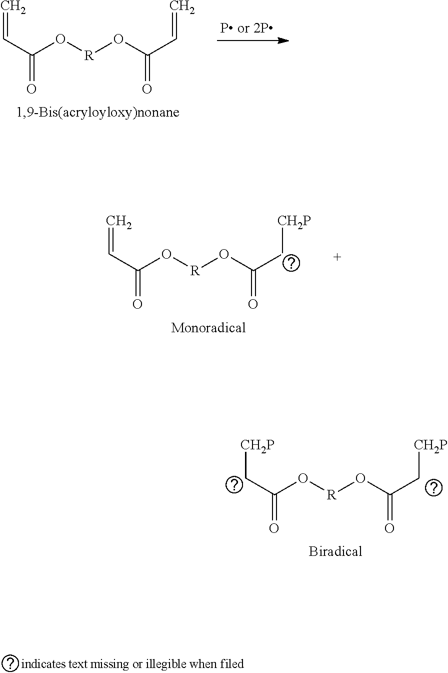

These crosslinking radicals can also react with polyisoprene to form cross-links between the polyisoprene chains.

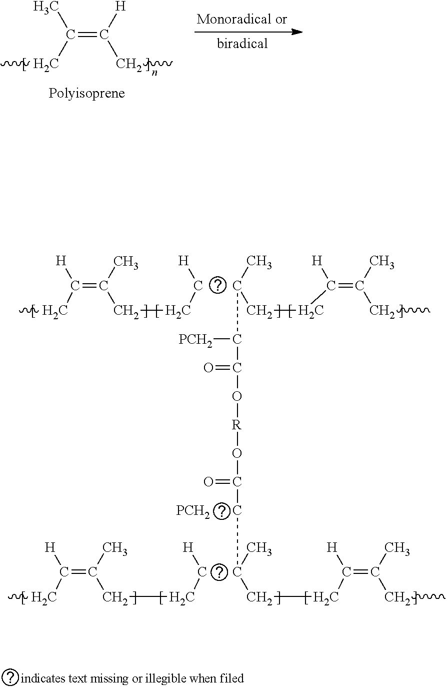

Preferably, the natural rubber of the backing layer has a dry rubber content (solid rubber content) of at least 40%, more preferably at least 50%, most preferably at least 60% by weight of the natural rubber. Such a dry rubber content provides the backing layer suitable properties for use in a backing layer of a floor covering element.

Preferably, at least a fraction of the natural rubber is obtained from a Hevea brasiliensis tree and/or Sf Ficus elastica tree. This is still the primary source of natural rubber today, but increased worldwide demand means that alternative sustainable sources are urgently required. The Russian dandelion (Taraxacum koksaghyz Rodin) is such an alternative because large amounts of natural rubber are produced in its root system. Hence, preferably, and even more preferably, at least a fraction of the natural rubber used in the backing layer is obtained from dandelions. Here, at least a fraction of the natural rubber is preferably obtained from a species of a Taraxacum genus, preferably at least one species chosen from the group consisting of: Taraxacum officianale, and Taraxacum kok-saghyz. Unlike Hevea rubber trees, Taraxacum kok-saghyz can be grown in temperate regions around the globe, including in North America and Russia. The backing layer may also comprise a mixture of two or more different natural rubbers and/or a mixture of at least one natural rubber and at least one synthetic rubber.

The thickness of the backing layer is preferably 1-2 mm.

Preferably, the floor covering element comprises at a first pair of opposite edge complementary coupling profiles configured to interlock adjacent floor covering elements, and wherein the floor covering element preferably comprises at a second pair of opposite edge complementary further coupling profiles configured to interlock adjacent floor covering elements. More preferably, the floor covering element is a floor panel with a first panel edge comprising a first coupling profile, and a second panel edge comprising a complementary second coupling profile being designed to, either directly or indirectly, interlock adjacent panels. In case of direct interlocking, a coupling profile of a panel will directly co-act with a complementary coupling profile of an adjacent panel. In case of indirect interlocking, typically a separate coupling structure (connecting element) is used to mutually couple of plurality of panels, wherein a coupling profile of each of said panel is coupled to the coupling structure. In coupled condition, the floor panels may abut each other, or, alternatively, may be positioned at a distance from each other. The floor panel may further comprise a third panel edge comprising a third coupling profile, and a fourth panel edge comprising a complementary fourth coupling profile being designed to, either directly or indirectly, interlock adjacent panels. In a preferred embodiment, the first coupling profile and/or the third coupling profile comprises: an upward tongue, at least one upward flank lying at a distance from the upward tongue, an upward groove formed in between the upward tongue and the upward flank wherein the upward groove is adapted to receive at least a part of a downward tongue of a second coupling profile of an adjacent panel, and at least one first locking element, preferably provided at a distant side of the upward tongue facing away from the upward flank, and wherein the second coupling profile and/or the fourth coupling profile comprises: a first downward tongue, at least one first downward flank lying at a distance from the downward tongue, a first downward groove formed in between the downward tongue and the downward flank, wherein the downward groove is adapted to receive at least a part of an upward tongue of a first coupling profile of an adjacent panel, and at least one second locking element adapted for co-action with a first locking element of an adjacent panel, said second locking element preferably being provided at the downward flank. Preferably, the first locking element comprises a bulge and/or a recess, and wherein the second locking element comprises a bulge and/or a recess. The bulge is commonly adapted to be at least partially received in the recess of an adjacent coupled panel for the purpose of realizing a locked coupling, preferably a vertically locked coupling. It is also conceivable that the first locking element and the second locking are not formed by a bulge-recess combination, but by another combination of co-acting profiled surfaces and/or high-friction contact surfaces. In this latter embodiment, the at least one locking element of the first locking element and second locking element may be formed by a (flat of otherwise shaped) contact surface composed of a, optionally separate, plastic material configured to generate friction with the other locking element of another panel in engaged (coupled) condition.

Preferably, the backing layer is substantially free of sulphur. This means that no sulphur (including sulphur-comprising agent(s)) is actively added to the natural rubber prior to crosslinking. In practice this means that the backing layer is preferably entirely free of sulphur, although it is imaginable that traces of sulphur (typically smaller than 0.1% by weight) may be present in the backing layer.

Preferably, the backing layer is substantially free of aniline. This means that no aniline (including aniline-comprising agent(s) and/or aniline derivates, such as phenylenediamines and diphenylamine) is actively added to the natural rubber and/or to the prior to crosslinking. As aniline is not naturally present in significant quantities in natural rubber, this means in practice that the backing layer may be entirely free of aniline, although it is imaginable that traces of aniline (typically smaller than 1% by weight) may be present in the backing layer. Hence, it is possible that traces of aniline could be present in natural rubber due to environmental contamination or processing methods. The presence of aniline in natural rubber would typically be undesirable because aniline can be toxic and has various health and environmental concerns associated with it. Having said the above, this does not exclude that aniline (including aniline-comprising agent(s) and/or aniline derivates, such as phenylenediamines and diphenylamine) may be present and/or may be added to the natural rubber and/or to the backing layer to inhibit oxidation of said natural rubber.

The decorative top structure is preferably at least partially transparent or translucent. The decorative top structure may be composed of a single layer, such as a printed decorative layer or a wear layer, but is typically composed of a plurality of layers. Preferably, the decorative top structure comprises at least one printed, more preferably digitally printed, decorative layer and at least one transparent wear layer and/or transparent top coating covering said decorative layer. Said top coating is also referred to as lacquer layer. The wear layer is preferably made of polyvinyl chloride, polyurethane, and/or acrylic resin(s). The decorative top structure may additionally comprise at least one back layer (primer layer) situated in between said decorative layer and the core, wherein said back layer is preferably made of a vinyl or polyurethane compound. A finishing layer may be applied in between the decorative layer and the wear layer. The decorative layer will be visible and will be used to provide the panel with an attractive appearance. To this end, the decorative layer may have a design pattern, which can, for example be a wood grain design, a mineral grain design that resembles marble, granite or any other natural stone grain, or a colour pattern, colour blend or single colour to name just a few design possibilities. Alternatively, the decorative top structure may also be formed by a textile-based and/or carpet-based top structure and/or another decorative top structure, such as a ceramic tile or layer, stone tile or layer, glass tile or layer, wooden tile or layer, marble tile or layer. These tiles or layer may be, for example, adhered to the core layer by means of at least one intermediate layer.

The core layer may comprise a (main) polymer, preferably a thermoplastic material, which is more preferably chosen from the group consisting of: PVC, PET, PP, PS, thermoplastic polyurethane (TPU), PE, in particular MDPE and/or HDPE; and combinations thereof. PS may be in the form of expanded PS (EPS) in order to further reduce the density of the floor covering element, which leads to a saving of costs and facilitates handling of the panels. Also in case another thermoplastic material is used, this material may be applied in foamed state in the core to reduce the density and costs. Nevertheless, it is also imaginable that the thermoplastic material used as main polymer is a solid polymer (i.e. an unfoamed polymer). Preferably, at least a fraction of the polymer used may be formed by recycled thermoplastic, such a recycled PVC or recycled PU. It is conceivable that a mix of virgin and recycled thermoplastic material is used to compose at least a part of the core. Instead of the thermoplastic material, also a thermoset polymer may be used, such as thermoset polyurethane.

At least a part of the core may be made of a composite material, such as a composite material comprising based upon of at least one polymer and at least one non-polymeric material. The composite of the core layer preferably comprises at least one polymer and one or more fillers, wherein at least one filler is preferably selected from the group consisting of: talc, chalk, wood, calcium carbonate, titanium dioxide, calcined clay, porcelain, glass, carbon particles, silicon particular, a(nother) mineral filler, a(nother) natural filler, a(nother) (auxiliary) polymer, such as an elastomer and/or latex. It is also imaginable that rubber and/or elastomeric parts (particles) are dispersed within the composite to improve the flexibility and/or impact resistance at least to some extent. The core may (thus) be rigid, semi-flexible, or flexible, and so can be the floor covering element as such. The filler may be formed by fibres, such as glass fibers or synthetic or genuine leather fibers, and/or may be formed by dust-like particles. Here, the expression “dust” is understood as small dust-like particles (powder), like bamboo dust, wood dust, cork dust, or non-wood dust, like mineral dust, stone powder, in particular cement, and combinations thereof. The average particle size of the dust is preferably between 14 and 20 micron, more preferably between 16 and 18 micron. The primary role of this kind of filler is to provide the core, and the panel as such, sufficient hardness and/or to decrease the cost price of the core, and hence of the panel. Moreover, this kind of filler will typically also improve the impact strength of the core and of the panel as such. Preferably, the filler content in the composite material of the core is between 30 and 75% by weight of the composite material of the core, more preferably between 60 and 70% by weight of the composite material of the core. Preferably, the polymer content in the composite material of the core is between 25 and 70% by weight of the composite material of the core, more preferably between 30 and 40% by weight of the composite material of the core. The polymer can either be foamed or unfoamed. Preferably, the composite of the core comprises at least one filler which acts as stabilizer, and which is preferably selected from the group consisting of: a salt, a stearate salt, calcium stearate, and zinc stearate. Stearates have the function of a stabilizer, and lead to a more beneficial processing temperature, and counteract decomposition of components of the composite during processing and after processing, which therefore provide long-term stability. Instead of or in addition to a stearate, for example calcium zinc may also be used as stabilizer. The weight content of the stabilizer(s) in the composite will preferably be between 1 and 5%, and more preferably between 1.5 and 4%. The composite of the core preferably comprises at least one impact modifier comprising at least one alkyl methacrylate, wherein said alkyl methacrylate is preferably chosen from the group consisting of: methyl methacrylate, ethyl methacrylate, propyl methacrylate, isopropyl methacrylate, t-butyl methacrylate and isobutyl methacrylate. The impact modifier typically improves the product performance, in particular the impact resistance. Moreover, the impact modifier typically toughens the core layer and can therefore also be seen as toughening agent, which further reduces the risk of breakage. Often, the modifier also facilitates the production process, for example, as already addressed above, in order to control the formation of the foam with a relatively consistent (constant) foam structure. The weight content of the impact modifier in the composite will preferably be between 1 and 9%, and more preferably between 3 and 6%. At least one plastic material used in the core layer is preferably free of any (toxic) plasticizer in order to increase the desired rigidity of the core layer, which is, moreover, also favourable from an environmental point of view. The core and/or another layer of the panel may comprise wood-based material, for example, MDF, HDF, wood dust, bamboo, prefabricated wood, more particularly so-called engineered wood. This wood-based material may be part of a composite material of the core.

Alternatively, the core is at least partially composed of another base material, such as a mineral material, like magnesium oxide, magnesium hydroxide, gypsum, (lightweight) concrete, and/or clay; and/or a wood or a wood-based material, such as HDF or MDF, or any other thermoplastic-free material, may be used as base material.

The natural rubber used in the backing layer of the floor covering element according to the invention may also be used in at least one other layer of the floor covering element, such as a layer of the decorative top structure, for example, underneath a decorative layer, and/or may be used to separate different sublayers (if applied) of the core layer. Here, it is for example imaginable that the decorative top structure is at least partially formed by at least one of the following tiles and/or layers: a ceramic tile or layer, a stone tile or layer, a glass tile or layer, a wooden tile or layer, a marble tile or layer. These tiles or layer may be, for example, adhered to the core layer by means of said natural rubber based intermediate layer, which is optionally provided with an (additional) adhesive layer in between said intermediate layer and said tile (or layer) positioned on top, and/or which is optionally provided with an (additional) adhesive layer in between said intermediate layer and said core layer. The intermediate rubber layer provides (dampening) comfort to the floor covering element. The intermediate rubber layer can compensate for differences in expansion coefficients between the decorative top tile (or decorative top layer, and/or alternative decorative top structure) and the core layer. This prevents undesired delamination in case of expansion and/or shrinkage.

In case this natural rubber is used in at least one other layer of the floor covering element, the backing layer may be omitted entirely and/or may be composed of a material other than said natural rubber, such as for example cork.

The invention also relates to a method of producing a decorative covering element according to the invention, comprises the steps of:
A) providing at least one core layer,
B) applying a decorative top structure, either directly or indirectly, on an upper side of said core layer,
C) applying a backing layer, either directly or indirectly, on a lower side of said core layer, wherein said backing layer
   i. either comprises an aqueous latex composition comprising rubber chains, at least one organic, preferably sulphur-free, crosslinking agent and at least one photo-initiator;
   ii. or comprises a prevulcanized layer of a partially cured natural rubber comprising partially crosslinked rubber chains, at least one organic, preferably sulphur-free, crosslinking agent, and at least one photo-initiator; and
D) subjecting the backing layer to UV radiation to transform at least a fraction of the photo-initiator into radicals which react with the rubber chains and the crosslinking agent to allow the crosslinking agent to form crosslinks in between said rubber chains.

During step C) the natural rubber can be applied as part of an aqueous latex composition, for example by pouring and subsequent rolling (egalizing), followed by the UV based curing step according to step D) to at least partially cure said natural rubber. The latex composition may also comprises one or more additives, like potassium laurate solution, an ammonium hydroxide solution, and/or toluene.

As indicated above, it is also imaginable that the natural rubber is applied as (prevulcanized) layer onto the core during step C), for example by means of calendaring, followed by the UV based curing step according to step D) to further cure said natural rubber.

During step D), preferably, the incident UV light preferably has a wavelength in the range of 250-350 nm. It is conceivable to apply a plurality of UV lamps, each irradiating UV with a preferred 250-350 nm wavelength, during step D). They may intensify the curing and/or cover a larger surface area which can be cured. The power of the UV lamps may vary, but is preferably between 5 and 15 Watt. The intensity of the incident UV radiation at the surface of the backing layer is preferably between 0.5 and 2 mW/cm2. The irradiation time may vary, but will typically be between 0.5 and 10 seconds, dependent on the composition applied during step C). The distance between the UV lamp(s) and the surface of the natural rubber, also referred to as irradiation distance is preferably situated in between 25 and 75 mm, and is more preferably 30, 45, or 60 mm, dependent on the desired natural rubber properties. For example, increasing the irradiation distance from 30 to 45 mm typically causes a certain increase in the tensile strength and the cross-link density. Further increase in the irradiation distance to, for example, 60 mm dramatically reduced both the tensile strength and the cross-link density of the natural rubber. The results can be explained by the strong effect of the irradiation distance on the intensity of the irradiation of the latex composition and therefore

on the coagulation during UV irradiation. As the irradiation distance decreases, the intensity of radiation intensifies and this enhances the efficacy of UV radiation in dissociating the photo-initiator into free radicals that initiate the cross-linking process. This could potentially lead to a higher cross-linking density and better tensile strength. Dependent on the desired eventual properties of the natural rubber, one could choose a preferred setting here.

Further embodiments of the invention are described in the non-limitative set of clauses presented below.

### CLAUSES

1 Decorative floor covering element, in particular a floor panel, comprising:
at least one core layer,
a decorative top structure affixed, either directly or indirectly, on an upper side of said core layer, and
a backing layer affixed, either directly or indirectly, on a lower side of said core layer,
   wherein said backing layer is at least partially composed of at least one partially UV cured natural rubber comprising rubber chains that are at least partially crosslinked by at least one organic, preferably sulphur-free, crosslinking agent, and which natural rubber comprises at least one photo-initiator and/or at least one photo-initiator derivative.

2. Floor covering element according to clause 1, wherein said natural rubber comprises rubber chains at least partially crosslinked by at least one branched organic, preferably sulphur-free, crosslinking agent.

3. Floor covering element according to clause 1 or 2, wherein said natural rubber comprises rubber chains at least partially crosslinked by at least one, preferably branched, organic, sulphur-free crosslinking agent.

4. Floor covering element according to any of the preceding clauses, wherein said natural rubber comprises at least one photo-initiator chosen from the group consisting of: α-hydroxyphenylketone, 2,2-dimethoxy-2-phenyl acetophenone, triarylphosphine oxide, bisacylphosphine oxide, 2-hydroxy-2-methyl-1-phenylpropanone.

5. Floor covering element according to any of the preceding clauses, wherein said crosslinking agent comprises at least one photo-initiator derivative.

6. Floor covering element according to any of the preceding clauses, wherein said crosslinking agent comprises at least one benzoyl group and/or at least one isopropanol group.

7. Floor covering element according to any of the preceding clauses, wherein said crosslinking agent comprises and/or is based upon acrylate.

8. Floor covering element according to any of the preceding clauses, wherein said crosslinking agent comprises and/or is based upon 1,9-bis(acryloyloxy) nonane.

9. Floor covering element according to any of the preceding clauses, wherein said rubber chains comprises cis-1,4-polyisoprene.

10. Floor covering element according to any of the preceding clauses, wherein a dry rubber content of said natural rubber is at least 40%, more preferably at least 50%, most preferably at least 60% by weight of the natural rubber.

11. Floor covering element according to any of the foregoing clauses, wherein at least a fraction of the natural rubber is obtained from a Hevea brasiliensis tree and/or Sf Ficus elastica tree.

12. Floor covering element according to any of the foregoing clauses, wherein at least a fraction of the natural rubber is obtained from dandelions.

13. Floor covering element according to any of the foregoing clauses, wherein at least a fraction of the natural rubber is obtained from a species of a Taraxacum genus, preferably at least one species chosen from the group consisting of: Taraxacum officianale, and Taraxacum kok-saghyz.

14. Floor covering element according to any of the preceding clauses, wherein said backing layer is directly attached to lower said of core, without intermediate adhesive.

15. Floor covering element according to any of the preceding clauses, wherein the crosslink density of the natural rubber is between 150 and 400 mol per kg natural rubber.

16. Floor covering element according to any of the preceding clauses, wherein the thickness of the backing layer is 1-2 mm.

17. Floor covering element according to any of the preceding clauses, wherein the floor covering element comprises at least a first pair of opposite edge complementary coupling profiles configured to interlock adjacent floor covering elements, and wherein the floor covering element preferably comprises at a second pair of opposite edge complementary further coupling profiles configured to interlock adjacent floor covering elements.

18. Floor covering element according to any of the preceding clauses, wherein the backing layer is substantially free of sulphur.

19. Floor covering element according to any of the foregoing clauses, wherein the backing layer is substantially free of aniline.

20. Floor covering element according to any of the foregoing clauses, wherein the decorative top structure comprises at least one printed decorative layer covered by at least one transparent wear layer.

21. Floor covering element according to any of the preceding clauses, wherein at least one functional layer is situated in between said core layer and said backing layer, and wherein said backing layer is directly attached to said at least one functional layer, preferably without intermediate adhesive.

22. Floor covering element according to any of the foregoing clauses, wherein the floor covering element is substantially rigid.

23. Method of producing a floor covering element according to any of the foregoing clauses, comprises the steps of:
A) providing at least one core layer,
B) applying a decorative top structure, either directly or indirectly, on an upper side of said core layer,
C) applying a backing layer, either directly or indirectly, on a lower side of said core layer, wherein said backing layer
   i. either comprises an aqueous latex composition comprising rubber chains, at least one organic, preferably sulphur-free, crosslinking agent and at least one photo-initiator;
   ii. or comprises a prevulcanized layer of a partially cured natural rubber comprising partially crosslinked rubber chains, at least one organic, preferably sulphur-free, crosslinking agent, and at least one photo-initiator; and
D) subjecting the backing layer to UV radiation to transform at least a fraction of the photo-initiator into radicals which react with the rubber chains and the crosslinking agent to allow the crosslinking agent to form crosslinks in between said rubber chains.

### BRIEF DESCRIPTION OF THE DRAWINGS

The terms Fig., Figs., Figure, and Figures are used interchangeably in the specification to refer to the corresponding figures in the drawings.

The invention will be further elucidated by several non-limitative embodiments according to the present invention, wherein:

FIG. 1 schematically shows a cross-sectional view of a decorative floor covering element according to the invention,

FIG. 2 schematically shows a perspective view of a decorative floor covering element according to the invention, and

FIG. 3 schematically shows a method for producing a decorative floor covering element according to the invention.

### DESCRIPTION OF THE INVENTION

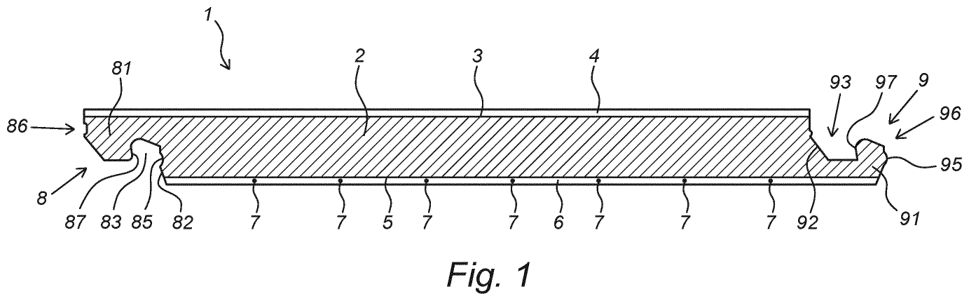

FIG. 1 shows a cross-sectional view of a decorative floor covering element 1 according to the present invention. The decorative floor covering element 1 can be a decorative floor panel, a decorative floor tile, a carpet tile or a carpet roll. The decorative floor covering element 1 comprises a core layer 2. On the upper side 3 of the core layer 2 a decorative top structure 4 is, directly or indirectly, affixed. At the lower side 5 of the core layer 2 a backing layer 6 is, directly or indirectly, affixed. The backing layer 6 is at least partially composed of at least one partially UV cured natural rubber comprising rubber chains at least partially crosslinked by a crosslinking agent, and which natural rubber comprises at least one photo-initiator and/or at least one photo-initiator derivative. The natural rubber is at least partially cured by exposing the natural rubber to UV radiation. It is possible that the at least partially cured natural rubber comprises traces of photo-initiator compounds 7 after being exposed to UV radiation. The crosslinking agent is preferably substantially free of sulphur, such as an acrylate crosslinking agent, to decrease the potential to cause allergic reactions on contact. The shown decorative floor covering element 1 further comprises a pair of opposite edge complementary coupling profiles 8, 9 configured to interlock adjacent decorative floor covering elements 1. The first coupling profile 8 comprises a downward tongue 81, a downward flank 82 situated at a distance from the downward tongue, and a downward groove 83 formed in between the downward tongue 81 and the downward flank 82, wherein the downward groove 83 is adapted to receive at least a part of an upward tongue 71 of the second coupling profile 9 of another decorative floor covering element 1. The side of the downward tongue 81 facing the downward flank 82 is the inside 87 of the downward tongue and the side of the downward tongue 81 facing away from the downward flank 82 is the outside 86 of the downward tongue 81. Optionally, a second locking element 85 adapted for co-action with a first locking element 75 of another decorative floor covering element 1, is provided at the downward flank 82. The second coupling profile 9 comprises an upward tongue 91, an upward flank 92 situated at a distance from the upward tongue and an upward groove 93 formed in between the upward tongue 91 and the upward flank 72, wherein the upward groove is adapted to receive at least a part of a downward tongue 81 of the first coupling part 8 of another decorative floor covering element 1. The side of the upward tongue 91 facing the upward flank 92 is the inside 97 of the upward tongue, and the side of the upward tongue 91 facing away from the upward flank 92 is the outside 96 of the upward tongue. A first locking element 95 is provided at an outside of the upward tongue 91 facing away from the upward flank 92. This embodiment shows coupling profiles 8, 9 that are configured to couple two adjacent decorative floor covering elements 1 by means of an angling down motion. It is however also possible that the decorative floor covering elements 1 comprise coupling profiles that are configured such that adjacent decorative floor covering elements 1 can be coupled to each other by means of a substantially fold-down movement and/or a vertical movement. It is furthermore imaginable that the decorative floor covering element 1 comprises a second pair of opposite edge complementary coupling profiles configured to interlock adjacent decorative floor covering elements 1.

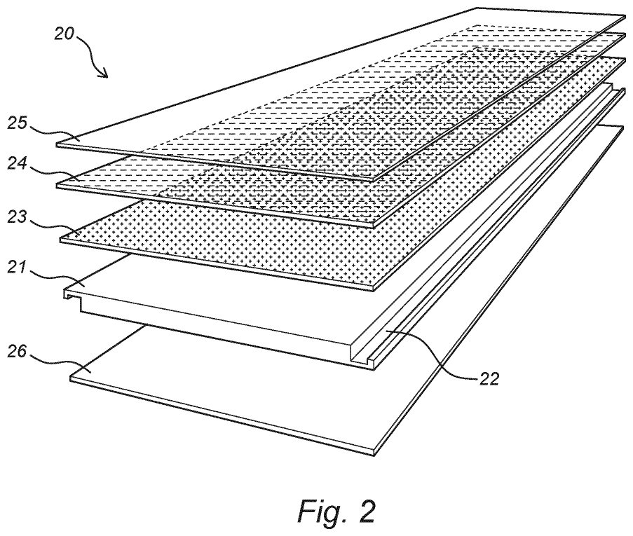

FIG. 2 schematically shows a perspective view of a decorative floor covering element 20 according to the invention. The decorative floor covering element 20 comprises a core layer 21 which comprises an upper side and a lower side. On the upper side of the core layer 21 a decorative top structure is affixed. It is imaginable that the decorative top structure comprises a decorative layer 23, a protective layer 24 and an UV-coating layer 25. The decorative layer 23 is, either directly or indirectly, affixed to the upper side of the core layer 21. The decorative layer 23 preferably is a (digitally) printed decorative layer 23. On top of the decorative layer 23 a protective layer 24 is, either directly or indirectly, affixed which covers the decorative layer 23. The protective layer 24 can comprise an embossing or a relief structure. Optionally, the decorative floor covering element 20 is provided with an UV-coating 25 that is attached to the decorative floor covering element 20 on top of the protective layer 24. Furthermore, a backing layer 26 is, either directly or indirectly, attached to the lower side of the core layer 21. It is imaginable that the backing layer 26 is directly attached to the lower side of the core layer 21, without the use of an intermediate adhesive. The backing layer 26 is at least partially composed of at least one partially UV cured natural rubber comprising rubber chains at least partially crosslinked by a crosslinking agent, and which natural rubber comprises at least one photo-initiator and/or at least one photo-initiator derivative. The core layer 21 further comprises coupling profiles 22 at decorative floor covering element 20 edges. The coupling profiles 22 enable the locking of decorative floor covering elements 20 to provide a floor covering. The coupling profiles 22 of this embodiment are configured such that adjacent decorative floor covering elements 20 can be coupled to each other by means of a fold-down movement and/or a vertical movement.

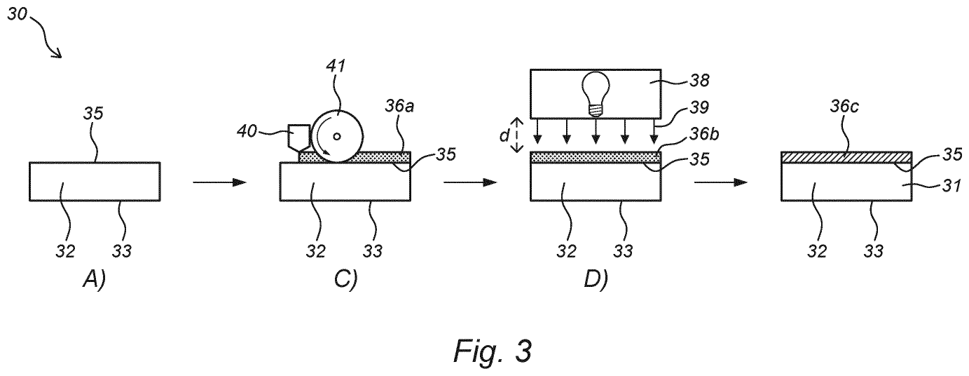

FIG. 3 schematically shows a method for producing a decorative floor covering element 31 according to the invention. For sake of clarity, the method comprises a production line 30. The production line 30 starts at a first stage A), where a core layer 32 is provided comprising an upper side 33 and a lower side 35. At a second stage C), a natural rubber 36a is applied on the lower side 35 of the core layer 32. The natural rubber 36a comprises rubber chains, at least one crosslinking agent, and at least one photo-initiator and/or at least one photo-initiator derivative. Preferably, the natural rubber 36a is substantially homogenous. The natural rubber 36a in this embodiment is applied to the lower side 35 of the core layer 32 via a natural rubber feed 40. The applied natural rubber 36a is subsequently equalised by a roll 41. Preferably, the natural rubber 36a is equalized by means of calendaring. It is imaginable that the natural rubber 36a is a prevulcanized natural rubber 36a comprising partially crosslinked rubber chains, at least one crosslinking agent, and at least one photo-initiator and/or at least one photo-initiator derivative. It is conceivable that the prevulcanized natural rubber 36a is initially provided on a roll 41. The prevulcanized layer can initially be covered by a peel-off coating to circumvent mutual adhesion. The roll 41 is preferably provided with a coating, such as a Teflon-coating, to circumvent the adhesion of the prevulcanized natural rubber 36a to the roll 41. It is furthermore possible that the lower side 35 of the core layer 32 is dipped into a bath containing the (uncured) natural rubber 36a. Due to the stickiness of the natural rubber 36a, the natural rubber 36a can be attached to the lower side 35 of the core layer 32 without an intermediate additive. An intermediate additive may however be used to attach the natural rubber 36a to the lower side 35 of the core layer 32. Subsequently at stage D), the natural rubber 36b is exposed to UV radiation 39 by an UV radiation source 38 to initiate the (partial) vulcanisation of the natural rubber 36b. Subjecting the natural rubber 36b to UV radiation 39 causes a transformation of at least a fraction of the photo-initiators in the natural rubber 36b into radicals. These radicals react with the rubber chains and the crosslinking agent in the natural rubber 36b allowing the crosslinking agent to form crosslinks in between the rubber chains. In case a prevulcanized natural rubber 36a was applied to the lower side 35 of the core layer 32, the natural rubber 36a is further vulcanized by exposing the prevulcanized natural rubber 36a to UV radiation 39. The UV radiation source 38 is positioned at a distance d from the natural rubber 36b. The distance d of the radiation source 38 and/or the intensity of the UV radiation 39 emitted by the UV radiation source 38 can be adjusted to provide the desired crosslinking density. In addition, the exposure time of the UV radiation 39 to the natural rubber 36b can be adjusted to provide the desired crosslinking density. The result is a core layer 32 provided with a backing layer 36c comprising an at least partially cured natural rubber 36c. Preferably, the resulting backing layer 36c has a thickness between 1-2 mm. The applied natural rubber 36a has a relatively low crosslink density resulting in a relatively high stickiness compared to the at least partially cured natural rubber 36c. Optionally, a decorative top structure is affixed, directly or indirectly, on the upper side 33 of the core layer 32 before affixing, either directly or indirectly, the backing layer 36 to the lower side 35 of the core layer 32 during stage B), not shown in this figure. It is also possible that the decorative top structure is affixed on the upper side 33 of the core layer 32 after affixing the backing layer 36 to the lower side 35 of the core layer 32. It is furthermore possible that the production line 30 comprises a stage E) wherein a cutting device or a milling device is provided to remove a part of the edge of the decorative floor covering element 31 to form one or more coupling profiles, such as a tongue and/or a groove. This figure is an illustrative example of steps of the method for producing a decorative floor covering element 31. It is conceivable that the method comprises an automated production line 30 to lead the core layer 32 through the different stages of the curing of the natural rubber 36a-c to produce a backing layer 36c at the lower side 35 of the core layer 32.

Hence, the above-described inventive concepts are illustrated by several illustrative embodiments. It is conceivable that individual inventive concepts may be applied without, in so doing, also applying other details of the described example. It is not necessary to elaborate on examples of all conceivable combinations of the above-described inventive concepts, as a person skilled in the art will understand numerous inventive concepts can be (re) combined in order to arrive at a specific application.

The “decorative floor covering element” according to the invention may also be referred to as floor panel or floor tile and/or may also applied as decorative wall covering element, decorative ceiling covering element, or alternative decorative covering element.

It will be apparent that the invention is not limited to the working examples shown and described herein, but that numerous variants are possible within the scope of the attached claims that will be obvious to a person skilled in the art.

The verb “comprise” and conjugations thereof used in this patent publication are understood to mean not only “comprise”, but are also understood to mean the phrases “contain”, “substantially consist of”, “formed by” and conjugations thereof.

1. A decorative floor covering element comprising:
at least one core layer,
a decorative top structure affixed, either directly or indirectly, on an upper side of said core layer, and
a backing layer affixed, either directly or indirectly, on a lower side of said core layer,
wherein said backing layer is at least partially composed of at least one partially UV cured natural rubber comprising rubber chains that are at least partially crosslinked by at least one organic crosslinking agent, and which natural rubber comprises at least one photo-initiator and/or at least one photo-initiator derivative, and wherein said backing layer is affixed, either directly or indirectly, on said lower side of said core layer, without intermediate adhesive.

2. The floor covering element according to claim 1, wherein said natural rubber comprises rubber chains at least partially crosslinked by at least one branched organic, sulphur-free, crosslinking agent.

3. The floor covering element according to claim 1, wherein said natural rubber comprises rubber chains at least partially crosslinked by at least one branched, organic, sulphur-free crosslinking agent.

4. The floor covering element according to claim 1, wherein said natural rubber comprises at least one photo-initiator chosen from the group consisting of: α-hydroxyphenylketone, 2,2-dimethoxy-2-phenyl acetophenone, triarylphosphine oxide, bisacylphosphine oxide, 2-hydroxy-2-methyl-1-phenylpropanone.

5. The floor covering element according to claim 1, wherein said crosslinking agent comprises at least one photo-initiator derivative.

6. The floor covering element according to claim 1, wherein said crosslinking agent comprises at least one benzoyl group and/or at least one isopropanol group.

7. The floor covering element according to claim 1, wherein said crosslinking agent comprises and/or is based upon acrylate.

8. The floor covering element according to claim 1, wherein said crosslinking agent comprises and/or is based upon 1,9-bis(acryloyloxy) nonane.

9. The floor covering element according to claim 1, wherein said rubber chains comprises cis-1,4-polyisoprene.

10. The floor covering element according to claim 1, wherein a dry rubber content of said natural rubber is at least 40% by weight of the natural rubber.

11. The floor covering element according to claim 1, wherein at least a fraction of the natural rubber is obtained from at least one option chosen from the group consisting of:
a Hevea brasiliensis tree and/or Sf Ficus elastica tree;
dandelions; a species chosen from the group consisting of: Taraxacum officianale and Taraxacum kok-saghyz.

12. (canceled)

13. (canceled)

14. The floor covering element according to claim 1, wherein said backing layer is directly attached to lower said of core layer, without intermediate adhesive.

15. The floor covering element according to claim 1, wherein at least one functional layer is situated in between said core layer and said backing layer, and wherein said backing layer is directly attached to said at least one functional layer, without intermediate adhesive.

16. The floor covering element according to claim 1, wherein the crosslink density of the natural rubber is between 150 and 400 mol per kg natural rubber.

17. The floor covering element according to claim 1, wherein the thickness of the backing layer is 1-2 mm.

18. The floor covering element according to claim 1, wherein the floor covering element comprises at least a first pair of opposite edge complementary coupling profiles configured to interlock adjacent floor covering elements, and wherein the floor covering element preferably comprises at a second pair of opposite edge complementary further coupling profiles configured to interlock adjacent floor covering elements.

19. The floor covering element according to claim 1, wherein the backing layer is substantially free of sulphur and/or substantially free aniline.

20. (canceled)

21. The floor covering element according to claim 1, wherein the decorative top structure comprises at least one printed decorative layer covered by at least one transparent wear layer.

22. The floor covering element according to claim 1, wherein the floor covering element is rigid.

23. A method of producing a floor covering element according to claim 1, comprises the steps of:
A) providing at least one core layer,
B) applying a decorative top structure, either directly or indirectly, on an upper side of said core layer,
C) applying a backing layer, either directly or indirectly, on a lower side of said core layer, wherein said backing layer
i. either comprises an aqueous latex composition comprising rubber chains, at least one organic crosslinking agent and at least one photo-initiator;
ii. or comprises a prevulcanized layer of a partially cured natural rubber comprising partially crosslinked rubber chains, at least one organic crosslinking agent, and at least one photo-initiator; and
D) subjecting the backing layer to UV radiation to transform at least a fraction of the photo-initiator into radicals which react with the rubber chains and the crosslinking agent to allow the crosslinking agent to form crosslinks in between said rubber chains.
